(19) United States
(12) Patent Application Publication
(10) Pub. No.: US 2010/0206765 A1
(43) Pub. Date: Aug. 19, 2010

(54) Medical compliance chart, organizer and dispenser

(76) Inventor: Elpidio A, Fonte, Clovis, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/378,391

(22) Filed: Feb. 13, 2009

(51) Int. Cl. A47B 67/00; G09F 3/18; E05B 65/44; B65D 83/04; G08B 23/00

(52) U.S. Cl. 206/534; 40/642.02; 312/245; 70/78; 340/573.1

(57) ABSTRACT

A medical compliance chart and dispenser for storing and dispensing medication that is easy and efficient to use and, if desired, carry from one place to another. The chart comprises a backing sheet having a plurality of medication containers attached thereto in a row and column arrangement which defines a calendar configuration so the user may have each day's medication inside a container designated for that day. The chart is utilized with packets of medication cooperatively sized with the containers to fit within a container chamber defined by walls of the container body. The packets are marked for the time of day to help the user remember to take medication and to avoid double taking it. The chart can be made out of stiff, hard materials or relatively soft, flexible materials that are easy to fold and carry. The chart can be mounted to a wall or inside a cabinet.

### BACKGROUND OF THE INVENTION

A. Field of the Invention

The field of the present invention relates generally to apparatuses for storing and dispensing medication. In particular, the present invention relates to such apparatuses that have a calendar mechanism to store, organize and dispense daily medication over a monthly time period. Even more particularly, the present invention relates to such apparatuses that are configured as a chart or cabinet having daily storage containers that hold medication to be taken at one or more times during the day so the user can determine what medications have been taken and which medications need to be taken.

B. Background

Medicine and other pharmaceuticals are typically prescribed to be taken by a patient at a regular rate over a set period of time, which may be a week, month, several months or for much longer periods of time. For some patients and some medications, the patient may be taking the medication for the rest of his or her life. Medications are typically provided in single compartment bottles or like containers that have a certain quantity of one medication inside the container with a label on the outside that tells the patient the regular daily dosage of the medication, usually expressed in a number of pills to be taken at certain frequencies throughout the day. For instance, the patient may be instructed to take the medication once a day, twice a day, three times a day or more often and to take the medications in the morning, afternoon and/or at night. Various other daily schedules are also possible depending on the medication and the need for the periodic treatment. Some medications are taken on a less than daily basis, such as once a week or once a month. For any medication, the key to successful treatment is that the medication be taken on the regular basis at or about the time of day or other period prescribed by the doctor. Failure to take the medicine as prescribed by the doctor can delay, sometimes significantly, the effects of the treatment and/or result in health complications for the patient. Taking more than the prescribed dosage of the medicine can also be harmful to the patient.

Unfortunately, many patients commonly forget to take one or more doses of their medication, sometimes even forgetting to take the medication for an entire day, or the patient accidently takes more than the daily prescribed dose of the medication. Typically, the failure to take the proper dosage, whether too little or too much, usually results from the patient's forgetfulness. Either the patient completely forgets to take a dose or forgets that he or she has already taken the medicine and then unintentionally retakes it. Remembering to take medication at the frequency prescribed when a person has only one prescription can be difficult, but is usually manageable. However, the problems with regard to taking medication at the required dosage is significantly compounded when a person has more than one prescription. A reality of medical treatment today is that many people are prescribed more than one medication at a time, whether taking multiple medications for a single medical issue or to treat more than one medical issue at a time. In fact, it is not uncommon for a person to have five, ten or more medications that he or she takes on a daily basis. The higher number of medications is particularly common for older patients, who may be taking several heart, blood pressure, cholesterol and other medications each day. As generally well known, different medications are typically dispensed in similar types of single drug bottles, each with their with their own instructions. Generally, the patient is required to sort out the various medications on his or her own and then remember to take the medications when prescribed. Because medications commonly have different dosage requirements with regard to when and how often they are taken, it can be easy for someone taking multiple medications to forget to take one or more of their pills during the day or to take more than the prescribed dosage. As well known, this problem is compounded if the person taking the medication has forgetfulness problems associated with age and/or a medical condition such as Alzheimer or the like.

Another problem with multiple medications is the need to store the medicine. As stated above, medication is typically dispensed in relatively small single medication bottles with a removable lid that is taken off to remove one or more pills from the bottle. If a person is taking a plurality of different medications, particularly if taking ten or more, he or she will have a shelf or drawer of bottles that must be managed so the medications are taken at the prescribed rate and time of day. Generally, it is most convenient and beneficial that the bottles are readily visible and accessible so the patient can more readily remember to take the medication when required. Unfortunately, leaving the medicine out where it is easy for the patient to see and remember to take is generally not recommended, particularly if other persons are in the home or are otherwise able to access the medications. It is a commonly known problem that persons having access to another person's medications may improperly take and abuse the medication, often causing serious health issues for the person who was not prescribed the medication. As a result, it is strongly recommended that a person secure the medications in a locked cabinet or the like. Unfortunately, the securing of the medication in this manner reduces the likelihood the medication will be taken as prescribed by the person for whom it was prescribed.

Another problem with regard to the management of medications, particularly multiple medications, is the ability to transport the medications as needed for travel or if the patient must see a doctor or be taken to the hospital. If a person will be away from his or her home for the day, a week or longer, then he or she must either separate out the medications that will be needed for that time period or take all of his or her medications, usually each in their separate bottles. Likewise, if the patient needs to see a doctor or go to the hospital, it is usually beneficial (if not mandatory) to take the medications with him or her so the doctor or other medical personnel will know what medications they are taking in order to avoid potentially harmful drug interactions. If an emergency situation arises, it can be difficult for the patient, the patient's family or assistant or the emergency personnel to gather all of the medications the person is taking, as well as any other pertinent medical information, for review by the emergency medical personnel prior to beginning any necessary, even lifesaving, treatment.

A number of prior art apparatuses and systems have been provided to assist patients with taking medications at the proper dosage. One common apparatus is a relatively small tray with seven compartments, one for each day of the week, that each have a lid which opens to allow a person to place all of the pills that are to be taken in one day in one of the compartments. Unfortunately, the pills for the day are mixed such that there is not segregation of the pills that are taken one, two, three or more times a day. As a result, the user cannot easily determine if he or she has taken the required dose for the day or whether it is time to take another pill. U.S. Pat. No. 4,534,468 to Nuckols, et al. describes a calendar-orientated pill dispenser comprising a backing sheet having a plurality of enclosures, one marked for each day of the month, that receives one or more pills therein with a rupturable region that allows the user to push the day's pill(s) out of the enclosure. U.S. Pat. No. 4,889,237 to Brandon describes a pill containing calendar that comprises an upright calendar holder with front and back panels positioned to receive a calendar therebetween so the date-indicating (day) squares can be seen through the transparent front panel. The front panel has slots sized for mounting a plurality of multi-compartment containers, with one of such containers aligned with one day on the calendar. Medication is placed inside the compartments of the container to remind the user to take the medication for that day. Although each of the foregoing offer assistance with regard to taking medication at the proper frequency, they have limitations that have prevented them from being commercially successful. One such limitation that is common to prior art apparatuses and systems pertains to the ability to manage medications having different dosage frequencies.

What is needed, is an improved apparatus and system for managing medications, particularly a plurality of medications that may have different dosage frequencies, so that the user can determine what medicine needs to be taken and whether or not he or she has taken the previous scheduled dose of the medicine. Preferably, the apparatus and system should comprise a calendar mechanism and a plurality of separate storage containers that allows the user to quickly and easily determine which medications have been taken to avoid retaking such medication and which medication needs to be taken to avoid missing a dose. The preferred apparatus and system should allow the user to manage multiple medicines that have different dosage frequencies and schedules. The apparatus and system should be adaptable for allowing the user to take all or a portion of the apparatus with him or her when away from the home or when he or she needs to go to the doctor or hospital. Preferably, the apparatus and system will allow medical personnel and others to easily and quickly determine what medications the user is taking and determine other pertinent medical information about the user.

### SUMMARY OF THE INVENTION

The medical compliance chart, organizer and dispenser of the present invention provides the benefits and solves the problems identified above. That is to say, the present invention discloses an apparatus and system that allows a user to better manage his or her medications so that the medications are taken when they are supposed to be taken and are not accidently re-taken. The medical compliance chart of the present invention is particularly suited to persons who have a plurality of medications and have medications that have different dosage frequencies to help the user with taking the medications at the prescribed frequency so as to avoid missing doses or doubling-up on doses. In a preferred embodiment, the apparatus and system comprises a calendar mechanism and separate compartments that cooperate with the calendar to assist the user in determining whether or not his or her medications have been or need to be taken. The apparatus and system are configured for the user to selectively take all or a portion of the apparatus and system with him or her when away from the home or when he or she needs to go to the doctor or hospital. The apparatus and system of the present invention assists the doctor or emergency personnel with knowing what medications the user is taking and assists the user in organizing his or her medical records, both of which are particularly useful in an emergency medical situation when the information may be needed to properly treat the user.

In a primary embodiment of the apparatus of the present invention, the medical compliance chart, organizer and dispenser is configured for use with a one or more packets of medicine that each contain one or more pills that are to be taken at different times during the day according to the user's prescribed medication dosage. The medical compliance chart and dispenser generally comprises a backing sheet having a plurality of medication containers on the front surface thereof that are each sized and configured to removably receive one or more packets of medication that each contain medication, generally in pill form, to be taken by the user. In a preferred embodiment, the packets are color coded or otherwise configured to indicate a time or day or other schedule for taking the medication so the user can easily determine what needs to be taken and what has already been taken. The medication containers are arranged on the front surface of the backing sheet in a calendar configuration of rows and columns that enable the user to schedule the medications he or she is to take during the month. A month label holder towards the upper edge of the backing sheet is configured to receive a month card having the name of the month thereon and each of the medication containers have a day label holder thereon for receiving a date label that indicates one day of the month. Each medication container has at least a front wall, a plurality of side walls and a top wall that defines a chamber that is sized and configured to removably receive the packets therein. The backing sheet and medication containers can be made out of stiff, hard materials or relatively flexible materials.

In a preferred embodiments, the backing sheet is made out of canvas or other cloth and the medication containers are made out of a soft plastic or cloth for ease of folding into a smaller sized package so the user may easily transport the chart to a doctor, hospital or elsewhere away from the home. In one configuration, the chart folds into a briefcase, which can be configured to also receive a laptop or other devices. The chart can be configured as a cabinet that is fixedly mounted on a wall or other vertical surface or it can be configured to be removably mounted on and supported by a wall or the inside of a cabinet. The chart can include one or more closeable pockets that can store medical-related information, including information pertaining to medical insurance, doctors, hospitals, medical history, allergies and family or other emergency contacts. One or more alarm devices can be utilized with the chart to remind the user that it is time to take his or her medication. In addition to making it easier for the user to remember to take medication and avoid double taking any medication, the chart of the present invention is useful for those who assist persons taking medication and for those who respond to the user in case of a medical emergency.

The present invention also describes a medical compliance system comprising a medical compliance chart and packets of medication that are utilized with the medical compliance chart to assist the user with taking the proper doses of the medication. The medical compliance chart has a backing sheet, a plurality of medication containers attached to the backing sheet and a support means attached to the backing sheet for supporting the medical compliance chart on a vertical surface or to allow the user to easily carry the medical compliance chart. The backing sheet has a front surface, back surface, top edge and bottom edge. The medication containers are disposed on the front surface in a plurality of rows and a plurality of columns that define a calendar configuration. Each of the medication containers has a container body with a front wall, one or more side walls and a top wall that define a chamber inside the container body. The medical compliance chart can include the features described above. The packets are cooperatively sized and configured with the chamber to be received in the chamber of each medication container. The packets have medication that the user or someone on his or her behalf places inside. Preferably each packet has an identifying means associated therewith for indicating when the medication is to be taken. The medical compliance system can also include an alarm system that is attached to or incorporated in the backing sheet and be configured to activate light and/or sound when the medication is to be taken so as to remind the user of the need to take the medication.

Accordingly, one of the primary aspects of the present invention is to provide a medical compliance chart, organizer and dispenser that has the advantages set forth above and which overcomes the disadvantages and limitations associated with presently available apparatuses and systems for managing medications.

It is an important aspect of the present invention to provide a medical compliance chart, organizer and dispenser that assists a user with managing his or her medications so he or she will take the medications at the prescribed frequency dosage in order to avoid missing one or more doses or taking more than the prescribed dosage.

It is also an important aspect of the present invention to provide a medical compliance chart, organizer and dispenser that has a calendar mechanism and a compartment associated with each day of the month that holds the medications the user is to take that day in a manner that allows for multiple daily doses of one or more of such medications.

It is also an important aspect of the present invention to provide a medical compliance chart, organizer and dispenser that is configured to allow the user or someone on his or her behalf to fill the apparatus at the beginning of each month so the user can beneficially utilize the chart/dispenser for the month with less chance of errors and less time.

Another important aspect of the present invention is to provide a medical compliance chart, organizer and dispenser that is configured for the user to easily and quickly take all or a portion of the apparatus with him or her when away from the location where the apparatus is normally utilized so the user may have access to the medications when he or she travels or the like.

Yet another important aspect of the present invention is to provide a medical compliance chart, organizer and dispenser that stores information relevant to the medical conditions of the user so that others, including emergency personnel may quickly have access to that information.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a front view of a medical compliance chart configured according to a preferred embodiment of the present invention shown in its extended condition with a plurality of compartments mounted on a support sheet;

FIG. 2 is a back view of the medical compliance chart of FIG. 1;

FIG. 3 is a front view of the medical compliance chart of FIG. 1 shown in its folded condition.

FIG. 4 is an isolated front perspective view of one compartment of the medical compliance chart of FIG. 1;

FIG. 5 is a front view of example packets of medication utilized with the medical compliance chart of FIG. 1;

FIG. 6 is a front view of a one week quantity of compartments shown separated from the support sheet of the medical compliance chart of FIG. 1;

FIG. 7 is a front view of an alternative embodiment of the medical compliance chart of the present invention shown configured as a cabinet with a plurality of trays and compartments therein with the doors in the open position;

FIG. 8 is a front view of the medical compliance chart of FIG. 7 with the doors shown in the closed position;

FIG. 9 is an isolated front perspective view of one compartment of the medical compliance chart of FIG. 7;

FIG. 10 is another alternative embodiment of the medical compliance chart of the present invention configured as a cabinet with a removable calendar portion on the left side and a plurality of shelves and a pocket on the right side thereof;

FIG. 11 is a front view of another alternative embodiment of the medical chart of the present invention configured as a briefcase shown in its extended position;

FIG. 12 is a back view of the chart of FIG. 11;

FIG. 13 is a back view of the chart of FIG. 11 shown in its folded or briefcase configuration for ease of transport and storage; and

FIG. 14 is a schematic view of a medical compliance alarm system that can be utilized with the medical chart of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The accompanying figures are merely illustrative of one or more of the preferred embodiments and, as such, represent one or more ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain uses and configurations for the medical compliance chart of the present invention, those who are skilled in the art will readily understand that this is merely for purposes of simplifying the present disclosure and that the present invention is not so limited.

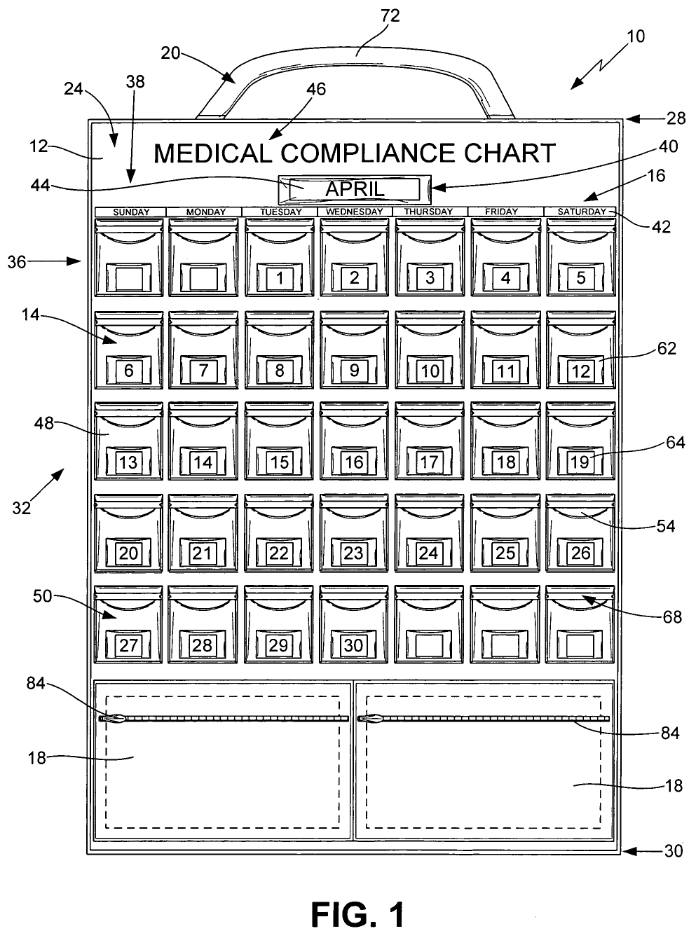

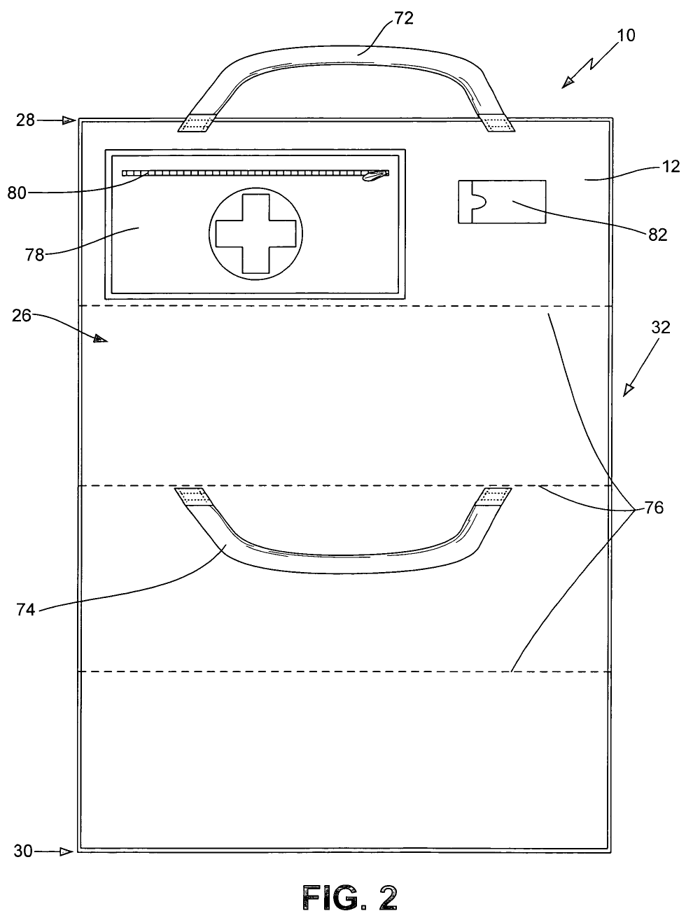

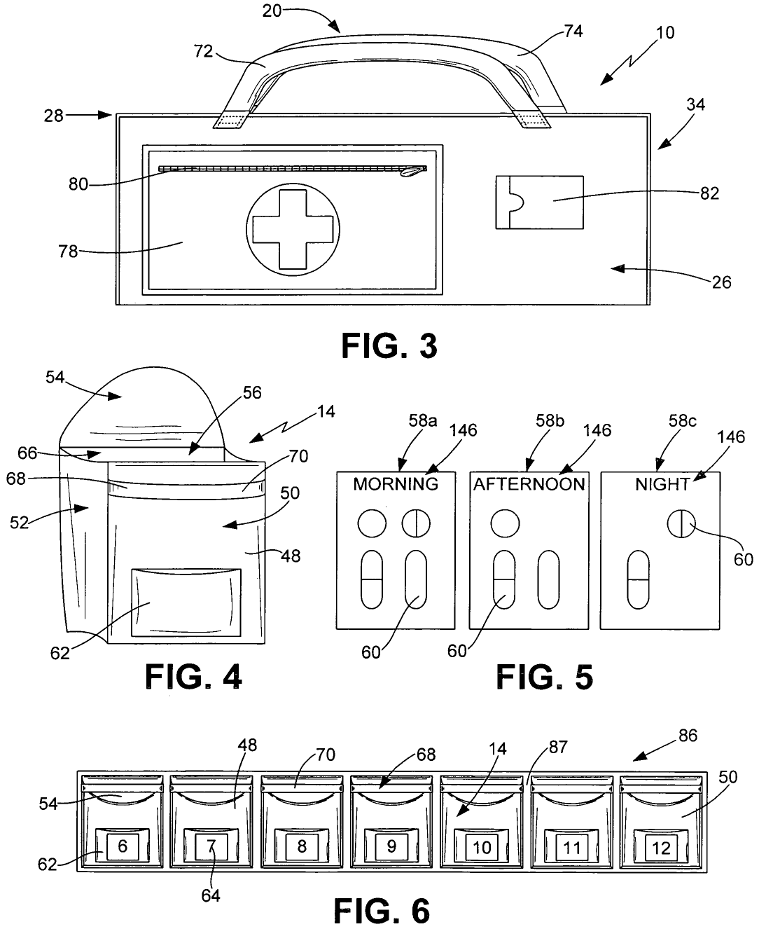

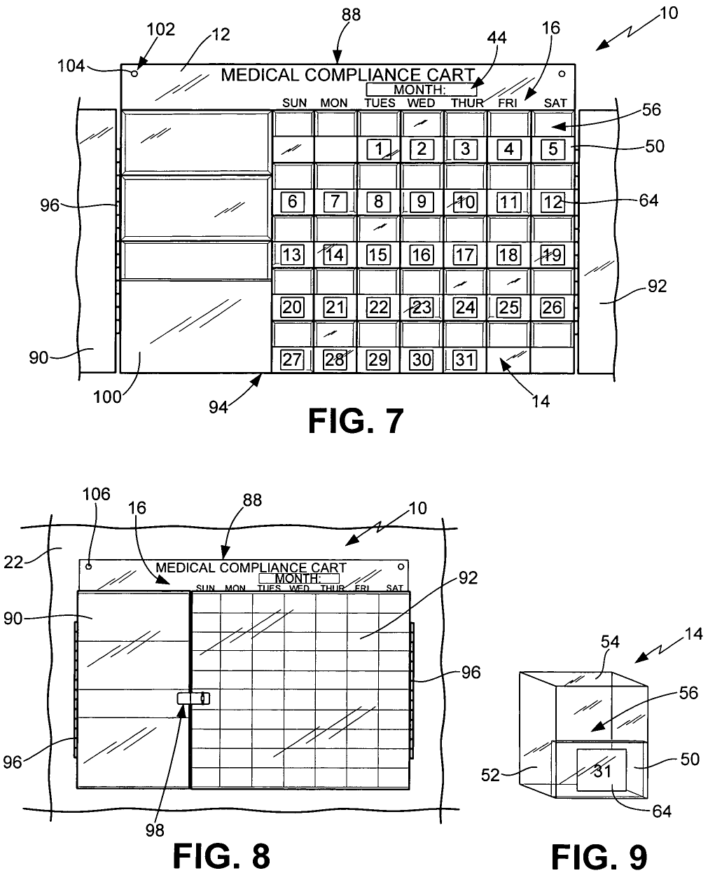

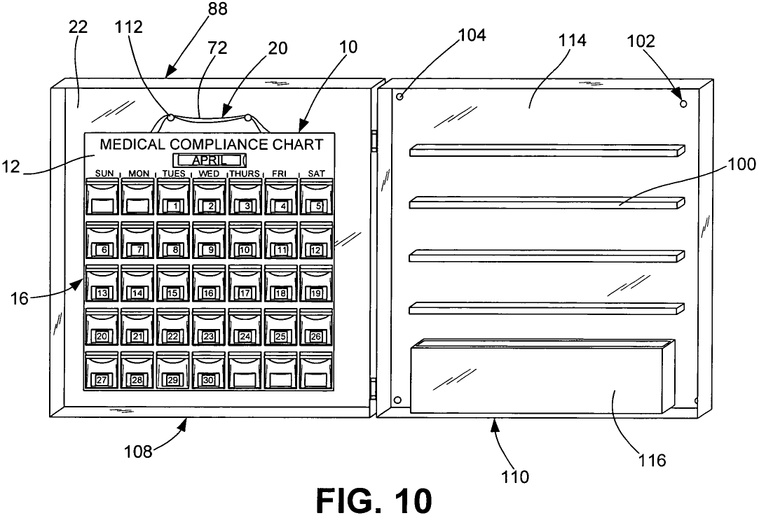

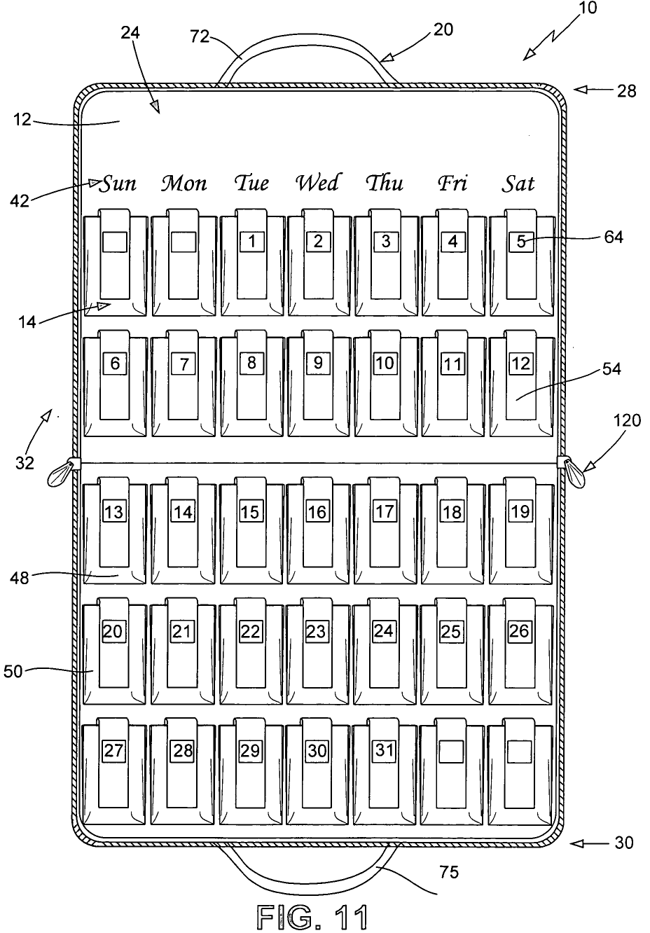

A medical compliance chart that is configured pursuant to a preferred embodiment of the present invention is shown generally as 10 in FIG. 1. The medical compliance chart and dispenser 10 generally comprises a support or backing sheet 12 having a plurality of daily medication containers 14 attached thereto in sufficient number and beneficially arranged in a calendar configuration 16, one or more storage pockets 18 and a support means 20 for supporting the chart 10 on a vertical surface 22, such as a wall or the like (as shown with regard to the embodiments of FIGS. 7 and 10), and/or allowing chart 10 to be carried by the user. As shown in FIGS. 1 and 2, backing sheet has a front surface 24, back surface 26, top edge 28 and bottom edge 30, with the medication containers 14 disposed on front surface 24 such that when chart 10 is in its extended position 32, as shown in these figures, medication containers 14 are readily accessible to the user. During the typical daily use of chart 10, back surface 26 will be placed against the vertical surface 22 and supported by its support means 20. Backing sheet 12 can be manufactured out of a wide variety of different materials and in different sizes and configurations. In one embodiment, backing sheet 12 is made out of a stiff material, such as a hard plastic, acrylic glass or like material. As set forth in more detail below, however, in a preferred embodiment backing sheet 12 is made out of a substantially flexible material such as canvas, cloth or cloth-like materials or a flexible plastic so it may be folded into a relatively small, easy to carry folded position 34, as shown in FIG. 3. In either configuration, the material or materials utilized for backing sheet 12 should be selected for the durability and, preferably, relatively light weight so that it may be easily supported on vertical surface 22 or carried by the user.

In a preferred embodiment of chart 10, the medication containers 14 are arranged in a calendar configuration 16 with five rows 36 of containers 14 disposed in seven columns 38, with each column 38 representing one day of the week, so as to provide a total of thirty-five containers 14, allowing the days of the month to be properly arranged with the days of the week. As shown in FIG. 1, preferably front surface 24 of backing sheet 12 is provided with a month label holder 40 mounted thereon above the calendar configuration 16 of containers 14 and a day of week label 42 for each day printed on front surface 24 above each column 38 of containers 14. Such configurations are commonly utilized for standard calendars. The month label holder 40 is preferably configured as a plastic pouch or the like that is configured to removably receive and display a month card 44 or like device having the name of the month printed thereon. If desired, the front surface 24 of backing sheet 12 can have the product name or other identifying label 46 printed thereon.

As best shown in FIG. 4, each medication container 14 comprises a container body 48 having a front wall 50, a plurality of side walls 52 and a top wall 54 that define a chamber 56 inside container 14 for removably receiving and storing a quantity medication, preferably provided in one or more packets, such as 58a, 58b and 58c shown in FIG. 5 and described in more detail below. The chamber 56 is sized and configured to allow the user or someone on his or her behalf to easily place packets, collectively identified as 58, inside container 14 and remove them as necessary to take medication 60 as prescribed (for purpose of the present invention, medication includes prescription drugs, non-prescription medication, including aspirin and many antihistamines, vitamins and the like that are typically supplied in pill form) best shown in FIG. 1, top wall 54 is configured to close chamber 56 so as to secure the medication packets 58 inside chamber 56. In a preferred embodiment, container body 48 of container 14 also comprises a day label holder 62 sized and configured to receive a date label 64 having a number thereon that corresponds to one day of the month such that when the date labels 64 are placed inside the day label holders 62 and the month card 44 is placed in month label holder 40 the chart 10 effectively displays a monthly calendar, as shown in FIG. 1. As with many calendars, in each month there will be a number of containers 14 that do not have a date label 64 that is associated therewith. The positioning of the blank day label holders 62 will shift as the first of the month shifts along the days of the week.

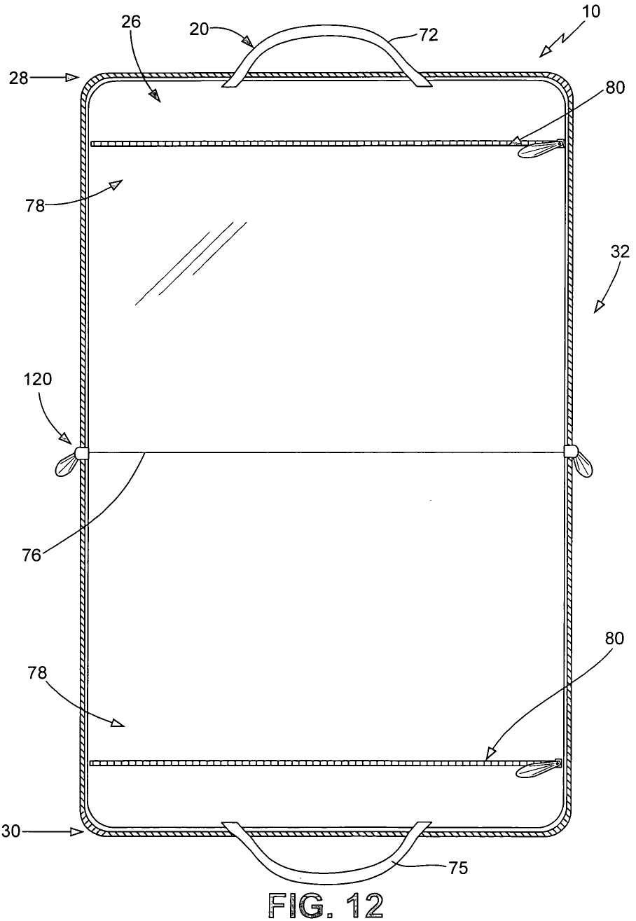

The containers 14 can be made out of a wide variety of materials. As with backing sheet 12, the containers can be manufactured out of a hard plastic or other stiff material or manufactured out of a substantially flexible material such as cloth or soft plastic. In a preferred embodiment, the backing sheet 12 is made out of canvas or cloth and the containers 14 are made out of a soft plastic or cloth to allow chart 10 to be easily folded into the folded position 34. In either configuration, top wall 54 should be configured to be secured to the front 50 and/or side 52 walls to close chamber 56. Preferably, top wall 54 is hingedly connected to either the front surface 24 of backing sheet 12 or to a back wall 66 that can further define the chamber 56 of container 14 so that the top wall 54 will not become separated from chart 10 and lost. In the embodiment shown in FIGS. 1 and 4, the containers 14 are made out of soft plastic that forms a built-in hinge between top wall 54 and back wall 66 so that top wall 54 can be folded over and close the open chamber 56 of container 14. In the embodiment of FIGS. 11 and 12, both backing sheet 12 and containers 14 are made out of a cloth or cloth-like material, which can be the same for both components, and top wall 54 is attached to backing sheet 14. Preferably, a closing means 68 is utilized to secure top wall 54 in a closed position to enclose packets 58 inside chamber 56. In a preferred embodiment, the closing means 68 is a strap member 70 placed across the front wall 50 and secured only at the edges thereof so a portion of the top wall 54 can be received between the front wall and strap member 70, as shown in FIG. 1, to close chamber 56. In the embodiment of FIG. 11, in which the top wall 54 only partially closes the top of chamber 56, closing means is a hook-and-loop material (e.g., Velcro®) positioned and configured to connect top wall 54 and front wall 50. Alternatively, the closing means 68 may comprise snaps, buttons, ties or other mechanisms well known in the art for closing chamber 56 with top wall 54. If the container 14 is made out of a substantially stiff material, such as a hard plastic or the like, top wall 54 can be configured such that it closes by frictionally engaging the top edges of the front 50 and/or side 52 walls. Alternatively, top wall 54 can merely rest on top of the front 50 and/or side 52 walls. Preferably, at least the front wall 50 of containers 14 are made out of a material and/or colored to reduce the likelihood of light, including indoor or outdoor light, does not damage the medication 60.

The preferred embodiment of chart 10 comprises one or more handles, such as top handle 72 and back handle 74 in FIGS. 1 through 3 or top handle 72 and bottom handle 75 in FIGS. 11 and 12, which can be utilized to support and carry chart 10. In one embodiment, an example of which is shown in the embodiment of FIG. 10, top handle 72 is also utilized to support chart 10 on a vertical surface 22, such as inside the cabinet shown (which is described below). Preferably, handles 72 and 74 are positioned on backing sheet 12 such that when chart 10 is placed in its folded position 34, as shown in FIG. 3, the handles 72 and 74 come together for the user to more easily carry chart 10. To facilitate folding chart 10 into its folded position 34, backing sheet 12 can comprise one or more fold lines 76, as shown in FIG. 2 on back surface 26, scored into backing sheet 12. The back surface 26 of baking sheet 12 can also comprise a back storage pocket 78, shown in FIGS. 2 and 3 with a first aid cross thereon, that can be utilized by the user for storing information that could be pertinent to the user if he or she must carry chart 10 to a doctor's office, the hospital or other location. Preferably, back storage pocket 78 has a back pocket closure means 80 thereon to allow the user to secure their information inside back storage pocket 78. The back pocket closure means 80 can be a zipper mechanism, as shown in FIGS. 2 and 3, or one of a variety of other pocket closure mechanisms well known in the art, including snaps, ties, buttons or the like. As shown in these figures, the back surface 26 can also comprise one or more card slips 82 that can be utilized to receive an insurance card, identification card and/or a variety of other cards, including business cards or the like, that may be useful for the user to have readily available if he or she takes chart 10 to the doctor or hospital.

A front storage pocket closure means 84 can be utilized with each of the front storage pockets 18, two of which are shown in FIG. 1, to allow the user to secure items therein. The front storage pocket closure means 84 can be the same type, such as the zippers shown, as back storage pocket closure means 80 or be a different type. The front storage pockets 18 can be utilized by the user to store identifying information (e.g., name, date of birth, etc.), medical insurance information, information regarding the user's medical conditions, a list of persons to contact in case of an emergency, allergy issues for the user, organ donation information, any do-not-resuscitate (DNR) orders, doctor and hospital information, a listing of medications the user is taking and what they are intended to be treating, any medical goals of the user (such as blood pressure, etc.) and like medical or medically related information. Some of this information may be stored in the back storage pocket 78 instead of the front storage pocket 18. The front storage pockets 18 can also be utilized to store medicine that is not taken on a regular basis, liquid medications and any topical medications or lotions.

In a preferred embodiment, chart 10 is configured so the user can remove one or more medication containers 14 to carry separate from chart 10 to help the user remember to take the medication 60 for the portion of time he or she will be away from chart 10. In one embodiment, the user can remove a single container 14 with the packets 58 therein sufficient for that day's supply of medication 60. In one embodiment, shown in FIG. 6, the chart 10 is configured for the user to remove a carry section, shown as 86, having seven containers 14 for a week's supply of packets 58. The use of carry section 86 allows the user to be gone for a week and be able to have his or her medication 60 readily available in the same system utilized at the home with chart 10. If the user is to be gone for more days, he or she can remove and take additional carry sections 86 with him or her. In a preferred embodiment, carry section 86 has a secondary backing sheet 87 to which a plurality of containers 14 are fixedly attached to define carry section 86 of a particular size, that being the number of days represented by the number of containers 14 attached to the secondary backing sheet 87. As with backing sheet 12, secondary backing sheet 87 can be made out of a relatively soft, flexible material such as cloth or soft plastic or it can be made out of a rigid, hard material such as plastic, wood or metal. Chart 10 can be configured with one or more fixed length carry sections 86, such as carry sections 86 configured for 3, 7 (as shown in FIG. 6) and/or 10 days. In one embodiment, the secondary backing sheet 87 of carry section 86 is removably attached to backing sheet 12 with a hook-and-loop material to allow the user to peel off carry section 86 when needed for travel and then easily reattach it when he or she returns.

As set forth above, the medication containers 14 of chart 10 are sized and configured to removably receive and store a plurality of packets 58 each having medication 60 therein. As stated above, medications 60 include prescription drugs, a variety of non-prescription medication and vitamins. In one embodiment, packets 58 are small, sealable plastic bags in which the user places medication 60 that is to be taken at a certain time of day, such as in the morning, afternoon or night, with each packet 58 having an identifying means 146 that is associated with a particular time of day when the medication 60 is to be taken. As shown in FIG. 6, the identifying means can comprise written words that state what time the medication 60 inside the particular packet 58a, 58b or 58c is to be taken by the user (based on dosage requirements). Alternatively, the identifying means can comprise the packets being color coded or otherwise distinguished to indicate what time of day the medication 60 is to be taken. In a preferred embodiment, packets 58 are relatively small and made out of aluminum foil or the like, similar to many conventional pill dispensing packages, that are “loaded” at the beginning of the month with the medication that is to be taken at a certain time of day or frequency. A wide variety of different types of small containers can be utilized for packets 58, including those that are relatively flexible, such as small plastic bags, and those which are relatively stiff, such as small hard plastic or metal containers. Preferably, any such container utilized for packet 58 will be configured to close in a manner that prevents medication 60 from falling out and becoming lose in containers 14, where it can be hard to retrieve or even become lost. As will be readily apparent to those skilled in the art, the medication 60 is grouped by those pills that are taken once a day (and at a particular time of day), those that are taken two times a day and those taken three times a day. Other time periods can also be provided, such as four or more times a day. The user will be able to easily and quickly determine whether he or she has yet taken the medication 60 for the particular time period so as to avoid missing a dosage or accidently taking a dose twice. Use of the color coding and/or labeling will allow the user to quickly retrieve the appropriate packet 58 for the time of day and take the medication 60 required for that time of day. Once the medication 60 is taken, the user disposes of the empty packet 58 in the trash.

In an alternative embodiment of the present invention, chart 10 is configured as part of a cabinet 88, as shown in FIGS. 7 through 9, or configured to be stored and utilized in a cabinet 88, as shown in FIG. 10. The embodiment of FIGS. 7 through 9 shown cart 10 made out of a clear, hard plastic material that can be molded to the desired configuration. The cabinet 88 of chart 10 in FIG. 7 shows use of a pair of doors 90 and 92 that are hingedly attached to the center section 94 of cabinet 88 with a hinges 96. As shown in FIG. 8, doors 90 and 92 are configured to close over the center section 94 to close chart 10 and prevent access to the medications 60 stored therein. Preferably, a locking mechanism 98 is utilized to secure doors 90/92 in the closed position. In this embodiment, as best shown in FIG. 9, medication containers 14 are configured as a small box or box-like structure having side walls 52 and top wall 54, which can be the bottom wall of the above container 14, with a mid-height front wall 50 that defines an opening (above front wall 50) into chamber 56. As with the previously described embodiment, the date label 64 can be configured to attach to front wall 50. The containers 14 can be molded integral with backing sheet 12. In addition, this configuration of chart 10 comprises one or more shelves 100, shown to the left of the containers 14 that make up the calendar configuration 16. The shelves 100 can be configured for standing a standard bottle of medication 60 that is used as the source to fill the packets 58 or for traditional containers of medication that are not suitable for packets 58, such as bottles containing liquid medicine, vitamins or the like.

As shown in FIG. 8, cabinet 88 is configured with a wall mounting means 102 for mounting the cabinet 88 on a wall or other vertical surface 22 so the user may place it in his or her home or other living area so he or she may easily access the medication 60 stored therein. In the embodiment shown in FIG. 7, wall mounting means 102 comprises one or more mounting apertures 104, typically a plurality, that are beneficially disposed in backing sheet 12 to support chart 10 on vertical surface 22. Each of the mounting apertures 104 should be configured to receive a screw, nail or other wall mounting mechanism 106 (shown in FIG. 8) therethrough to connect, as well known in the art, to a stud or other secure portion of the vertical surface 22.

FIG. 10 shows a cabinet 88 that is configured to be utilized with the medical compliance chart 10 of the present invention. The cabinet 88 shown has a first cabinet section 108 that is hingedly connected to a second cabinet section 110 such that the cabinet 88 can be closed. Although not shown, one or more locking mechanisms can be utilized with this cabinet 88 to lock the first cabinet section 108 onto the second cabinet section 110. The first cabinet section 108 has one or more hanging mechanisms 112 that are configured to cooperatively engage the support means 20 to hang chart 10 on or in first cabinet section 108. In one embodiment, the hanging mechanism 112 is one or more pegs and the support means 20 is top handle 72. Various hooks or other projecting devices, as well as other devices, can be attached to the back wall 22 (vertical surface) or one or more of the side walls of first cabinet section 108. The back wall 114 of the second cabinet section 110 has a wall mounting means 102 for mounting the second cabinet section 110 on a wall or other surface. In the embodiment shown in FIG. 10, the mounting means is a four mounting apertures 104 configured to accept a mounting mechanism 106. The cabinet shown also has a plurality of shelves 100, which can be utilized as set forth above, and an open-top tray 116 that is useful for storing medical-related information, including information that pertains to medical insurance, the user's medical conditions, allergies, doctors, family contact information and the like.

The cabinets 88 described above can be utilized as part of a medical station that is placed in the home or other living location for the user of chart 10 of the present invention. In addition to cabinet 88 having chart 10, the medical station can comprise various other health/medical related components that can effectively provide the user with an area of the home where he or she can take medication 60 and follow any other medical issues that they may exist. For instance, the medical station can include a small refrigerator for medicine that needs to be refrigerated, a table where the user can sit at to arrange the chart 10, take blood pressure or perform other medically related tasks, a chair to sit on next to the table, a telephone and/or Internet hook-up, an emergency alarm system and the like. If desired, the medical station can include a sink or other supply of water to assist in taking medication 60 and/or a record keeping system so the user can record food and/or water intake and the taking of medication, blood pressure, weight and any other pertinent medical information. A medical station can also include a needle dispenser for receiving used needles and a waste receptacle for receiving other wastes. Preferably, the medical station is placed in a corner of the house or at another location where the medical station can be enclosed behind one or more doors that can be locked to prevent unauthorized persons from having access to the medical station, including the medication 60 in chart 10. In addition to being convenient for the user, the use of a medical station having chart 10 will make it easier for a nurse or other care provider to assist the user or for emergency medical personnel to treat the user in case of a medical emergency.

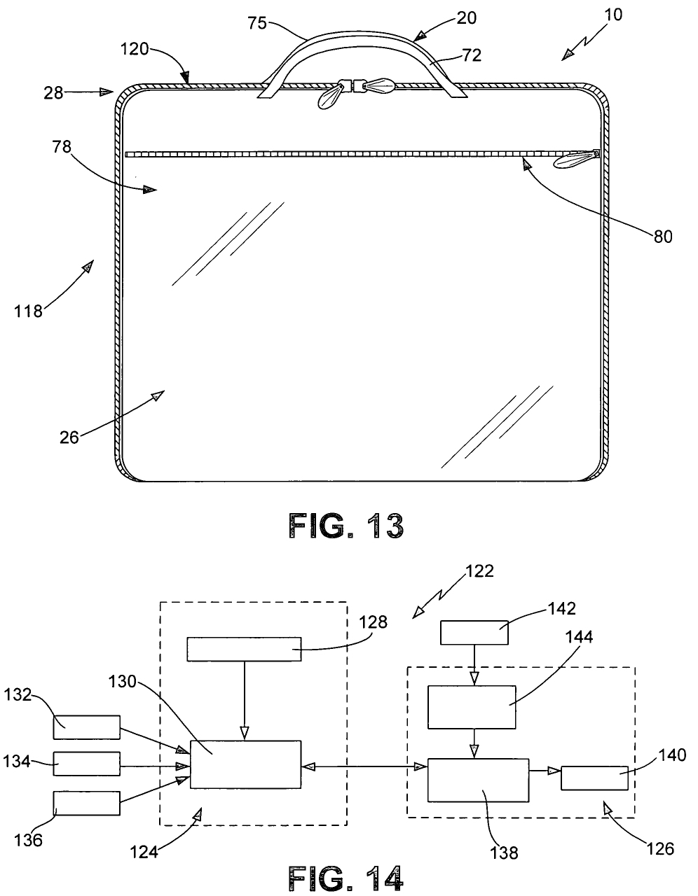

The embodiment of FIGS. 11 through 13 show chart 10 configured to be folded into a briefcase 118 (FIG. 13) to make chart 10 significantly easier for the user to carry chart 10 with him or her when going to the doctor, hospital or otherwise away from the home or other location where chart 10 is normally utilized. FIGS. 11 and 12 show the briefcase 118 in its extended position 32 that can be hung on a wall or other vertical surface, including be utilized with a cabinet 88. In a preferred embodiment, the briefcase 118 has a top handle 72 and a lower handle 75 that join together when the case 10 is folded at or near the middle of backing sheet 12 and a case closure means 120 that is configured to allow the user to securely close case 10 in the briefcase 118 configuration. As shown, the case closure means 120 can comprise a zipper mechanism that is on the outer edge of the backing sheet 12. Preferably, the backing sheet 12 and the various medication containers 14 are made out of a relatively soft, flexible material, such as cloth, leather or the like, so that it may be easily folded into the briefcase 118 and then unfolded to its extended position 32 for hanging on a wall or in a cabinet 88. In the embodiment shown in FIG. 11, top wall 54 is only wide enough to prevent packets 58 from falling out of the chamber 56 defined by the container body 48 of containers 14 and the closing means 68 (not shown) to close top wall 54 to the front wall 50 is a hook-and-loop material such as Velcro®. If desired, closing means 68 can comprise a magnet one of top wall 54 and front wall 50 and a magnetically cooperative component, which can be a piece of ferrous metal or another magnet, in the other so that the top wall 54 and front wall 50 are magnetically joined to close chamber 56.

To assist the user with efficient and effective use of the medical compliance chart 10 of the present invention, the chart 10 can include various electronic components that help remind the user of his or her need to take any required medication and/or to track the medication that was taken. In one embodiment, the chart 10 can include one or more lights that can be configured to blink at the time of day that the user is required to take some medication. The chart can include a mechanism to set a timer that activates the blinking light and which allows the user to turn off the light once he or she has taken the medication associated with the activation of the light. In addition, chart 10 can include, or alternatively utilize, a voice alarm system that activates a voice or other sound that informs the user that it is time to take his or her required medicine. The use of light and/or sound alarms will be particularly useful for patients who tend to forget their medication or for persons who have diminished mental capacity and need some type of alarm system. Such a system will be particularly useful for persons having memory and/or cognitive medical issues. In the preferred embodiment, the alarm system will be easily programmable by the user. The voice system can be configured to allow the user to record his or her own voice or record the voice of a spouse, parent, child or other person to remind him or her, perhaps in a gentler fashion, to take the medication 60.

An example medical compliance alarm system 122 is shown in FIG. 14. The alarm system 122 of FIG. 14 comprises an alarm programmer module 124 and an alarm module 126 that are attached to or incorporated into the backing sheet 12 of chart 10. In a preferred embodiment, the alarm programmer module 124 comprises an LCD screen display 128 and a programmer controller 130, which is configured to receive multiple inputs, such as first input 132, second input 134 and third input 136. As known to those skilled in the art, various other inputs can also be allowed with alarm system 122. The inputs can include the number of times the alarm will trigger each day, the time for the alarm to activate and a clock setting function that allows the user to set the clock or change time as necessary. The alarm module 126 can comprise an alarm controller 138 that is configured to activate an alarm 140, which can be a light and/or a sound alarm. A fourth input 142 can be utilized to allow the user to record a voice or other sound to a recorder 144 that is operatively connected to the alarm controller 138. Utilizing alarm system 122, the user can set a plurality of alarms that remind him or her to take medication 60 at different times of the day. Preferably, the alarm system 122 is configured to recognize the day of week and month so that it can effectively ensure that the proper medication 60 is taken. The user can utilize up and down buttons to set the time, alarm or other features, a mode button to select between a time setting, alarm setting, alarm type and recording operations and a select button to allow the user to confirm his or her selections. The LCD display 128 displays the necessary information to the user. In a preferred embodiment, every time the alarm 140 activates, sound and light indicators will go off to inform the user that it is time to take medication. The alarm system 122 can be powered by one or more batteries, preferably rechargeable, and/or be operatively attached to a standard supply (i.e., an outlet) of electricity.

Various modifications can be made to the medical compliance chart of the present invention. For instance, the labels utilized to indicate the month, day of week, day and the identifying means 146 can be configured in Braille so that persons having limited or no sight can utilize chart 10 to assist him or her with the proper taking of the medication 60. The chart 10 can be made to be very small, for instance having a folded size of approximately six inches wide by six inches high by one inch thick, to make chart 10 even more portable. The chart 10 of the present invention can be utilized as an organizational chart or calendar. In one configuration, alarm system 122 can be configured to transmit voice messages that tells the user what activities, such as meetings or other appointments, are going on that day. The alarm system 122 can also be configured to activate an alarm to wake the person up from sleep, warn him or her of an upcoming meeting or other appointment and remind him or her what needs to be done that day. The organizing function could be utilized with the medical compliance functions, as set fort above, or the user can utilize the chart 10 as a stand-alone organizer.

In use, the user will load the packets 58 with the medication 60, with each packet 58 receiving medication 60 that is to be taken at a particular time of day, such as the morning, afternoon and night, as associated with the identifying means 146 on the packets 58. One benefit of chart 10 is that a caregiver can assist the patient or someone on his or her behalf with loading the packets 58 at the beginning of each month. Once done, the user would not have to worry about scheduling his or her medications for the month, thereby reducing the likelihood of medication errors and with amount of time the user must direct to handling his or her medications 60. Another advantage of the chart 10 and system of the present invention is that the user's pharmacy can provide the user with his or her medication 60 already in packets 58 for the entire month. The packets 58 can be a sealed blister pack type of package that has the different doses throughout the day already arranged by the pharmacy. The user could obtain a month or more supply of pre-loaded packets 58 already arranged by the doses throughout the day, thereby further lessening the likelihood of errors and the amount of time the user must direct to handling his or her medications 60.

Once loaded, the packets 58 for each day are then placed inside the chamber 56 of medication container 14 and the top wall 54, if utilized, is covered over the chamber 56 and attached to the front 50 and/or side 52 walls to close the packets 58 inside chamber 56. Typically, this loading of the packets 58 and placement inside the containers 14 will be done at the first of each month. At such time, the month card 44 can be placed inside the month label holder 40 and the date labels 64 can be placed inside the day label holders 62 to define the calendar configuration 16 of chart 10. If chart 10 is not already attached to a wall or other vertical surface 22, then chart 10 can be hung on a hanging mechanism 112 by one or more of its support means 20, which will typically be one or more handles (such as top handle 72). If the chart 10 is used with a cabinet 88, the cabinet 88 can be closed and locked to prevent others from accessing the medication 60 without permission from the user. Pertinent medical information, including personal identifying, insurance, doctor, medical history and other information can be stored in one or more storage pockets, such as pockets 18 or 78. If the user needs to go to the doctor or a hospital or desires to be away from the home for an extended period of time, he or she can take the chart 10 off of the wall or other vertical surface 22 and place it in its folded position 34 or, if properly configured, place it in its briefcase 118 configuration for ease of transport and storage. The user can also utilize chart 10 as a readily available organizer by placing a memo card, sticky note or other memory device inside chamber 56 or on the outside of container 14 for the appropriate day. In this manner, the chart 10 can help the user remember doctor appointments, birthdays or any other important events. Because the user will be accessing chart 10 for his or her medications 60, the memory devices will be readily available to remind the user of chart 10.

While there are shown and described herein one or more specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A medical compliance chart for use with one or more packets each containing medication, said medical compliance chart comprising:
a backing sheet having a front surface, a back surface, a top edge and a bottom edge;
a plurality of medication containers on said front surface configured in a plurality of rows and a plurality of columns defining a calendar configuration, each of said medication containers having a container body with a front wall and one or more side walls defining a chamber sized and configured to receive and store said packets of said medication; and
support means attached to said backing sheet for supporting said medical compliance chart on a vertical surface and/or for carrying.

2. The medical compliance chart according to claim 1 further comprising one or more storage pockets on or integral with said backing sheet.

3. The medical compliance chart according to claim 1, wherein said backing sheet is configured to move between an extended position and a folded position.

4. The medical compliance chart according to claim 4, wherein said medical compliance chart can be configured as a briefcase.

5. The medical compliance chart according to claim 1, wherein said back surface has one or more back storage pockets.

6. The medical compliance chart according to claim 1, wherein said backing sheet comprises a month label holder sized and configured to receive a month card therein.

7. The medical compliance chart according to claim 1, wherein each of said medication containers further comprises a top wall configured at least partially cover said chamber to secure said packets therein.

8. The medical compliance chart according to claim 7 further comprising a closing means on said container body for securing said top wall to at least one of said front wall and said side walls.

9. The medical compliance chart according to claim 1, wherein said front wall of said container body has a day label holder sized and configured to receive a day label.

10. The medical compliance chart according to claim 1 further comprising one or more carry sections removably attached to said front surface of said backing sheet, each of said carry sections comprising a plurality of said medication containers attached to a secondary backing sheet.

11. The medical compliance chart according to claim 1, wherein said medical compliance chart is configured as a cabinet having one or more wall mounting means on said backing sheet for mounting said cabinet to a vertical surface.

12. The medical compliance chart according to claim 11, wherein said cabinet further comprises one or more shelves and a means for locking said cabinet to prevent unauthorized access to said medication in said medication containers.

13. The medical compliance chart according to claim 1 further comprising an alarm system attached to or incorporated in said backing sheet, said alarm system having an alarm configured to activate light and/or sound when medication is to be taken by the user of said medical compliance chart.

14. A medical compliance chart for use with one or more packets each containing medication, said medical compliance chart comprising:
a backing sheet having a front surface, a back surface, a top edge and a bottom edge, said backing sheet configured to move between an extended position for mounting on a vertical surface and a folded position for carrying;
a plurality of medication containers on said front surface configured in a plurality of rows and a plurality of columns defining a calendar configuration, each of said medication containers having a container body with a front wall, one or more side walls and a top wall defining a chamber sized and configured to receive and store said packets of said medication; and
support means attached to said backing sheet for supporting said medical compliance chart on a vertical surface and/or for carrying,
wherein each of said packets have an identifying means associated therewith to indicate when said medication is to be taken

15. The medical compliance chart according to claim 14, wherein said medical compliance chart can be configured as a briefcase.

16. The medical compliance chart according to claim 14 further comprising one or more pockets on or integral with said front surface and/or said back surface of said backing sheet.

17. The medical compliance chart according to claim 14, wherein each of said medication containers further comprises a closing means on said container body for securing said top wall to at least one of said front wall and said side walls.

18. The medical compliance chart according to claim 14 further comprising one or more carry sections removably attached to said front surface of said backing sheet, each of said carry sections comprising a plurality of said medication containers attached to a secondary backing sheet.

19. A medical compliance system, comprising:
a medical compliance chart having a backing sheet, a plurality of medication containers attached to said backing sheet and a support means attached to said backing sheet for supporting said medical compliance chart on a vertical surface or for carrying, said backing sheet having a front surface, a back surface, a top edge and a bottom edge, said plurality of medication containers disposed on said front surface in a plurality of rows and a plurality of columns defining a calendar configuration, each of said medication containers having a container body with a front wall and one or more side walls defining a chamber; and
one or more packets sized and configured to be received in said chamber of each of said plurality of medication containers, said packets having medication therein, each of said packets having an identifying means associated therewith for indicating when said medication is to be taken.

20. The medical compliance system according to claim 1 further comprising an alarm system attached to or incorporated in said backing sheet, said alarm system having an alarm configured to activate light and/or sound when said medication is to be taken.
